(19) United States
(12) Patent Application Publication
(10) Pub. No.: US 2021/0334712 A1
(43) Pub. Date: Oct. 28, 2021

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Shin SAKURADA, Toyota-shi (JP); Kazuya NISHIMURA, Toyota-shi (JP); Masaru ANDO, Seto-shi (JP); Toshinari HONDA, Anjo-shi (JP)

(73) Assignee: TOYOTA JIDOSHA KABUSHIKI KAISHA, Toyota-shi (JP)

(21) Appl. No.: 17/234,092

(22) Filed: Apr. 19, 2021

(30) Foreign Application Priority Data
Apr. 22, 2020 (JP) 2020-075857

(51) Int. Cl. G06Q 10/02; G06Q 10/06; G06Q 30/06

(52) U.S. Cl. CPC G06Q 10/02; G06Q 30/0645; G06Q 10/06315

(57) ABSTRACT

The present disclosure enables equipment not provided in a company vehicle to be rented out to a user together with the company vehicle. An information processing apparatus of the present disclosure includes a controller that is configured to acquire a use application to privately use a company vehicle that is used by the company for business activity, from a user who is an employee of a company, specify equipment that is able to be rented out together with the company vehicle to be rented out to the user and that is not provided in the company vehicle, as recommended equipment, based on the use application, and supply guide information suggesting rental of the recommended equipment to a user terminal.

### CROSS REFERENCE TO THE RELATED APPLICATION

This application claims the benefit of Japanese Patent Application No. 2020-075857, filed on Apr. 22, 2020, which is hereby incorporated by reference herein in its entirety.

### BACKGROUND

### Technical Field

The present disclosure relates to an information processing apparatus, an information processing method, and a non-transitory storage medium.

### Description of the Related Art

Patent document 1 discloses a company/employee car sharing system for enabling car-sharing between a company and an employee, according to which a company rents out a leased vehicle leased from a leasing company or a vehicle that the company owns to an employee for personal use.

[Patent document 1] Japanese Patent Laid-Open No. 2019-061575

### SUMMARY

One or more aspects of the present disclosure are directed to provide a technique that enables equipment not provided in a company vehicle to be rented out to a user together with the company vehicle.

An information processing apparatus according to an aspect of the present disclosure may include a controller that is configured to execute: acquiring a use application to privately use a company vehicle that is used by the company for business activity, from a user who is an employee of a company; specifying equipment that is able to be rented out together with the company vehicle to be rented out to the user and that is not provided in the company vehicle, as recommended equipment, based on the use application; and supplying guide information suggesting rental of the recommended equipment to a user terminal.

An information processing method according to an aspect of the present disclosure may be performed by a controller, the method including: acquiring a use application to privately use a company vehicle that is used by the company for business activity, from a user who is an employee of a company; specifying equipment that is able to be rented out together with the company vehicle to be rented out to the user and that is not provided in the company vehicle, as recommended equipment, based on the use application; and supplying guide information suggesting rental of the recommended equipment to a user terminal.

An aspect of the present disclosure may be a non-transitory storage medium storing a program for causing a controller to perform the information processing method described above.

According to the present disclosure, a technique that enables equipment not provided in a company vehicle to be rented out to a user together with the company vehicle may be provided.

### BRIEF DESCRIPTION OF THE DRAWINGS

FIG. 1 is a diagram illustrating a schematic configuration of an information processing system;

FIG. 2 is a diagram illustrating a sequence of processes that are performed by a vehicle management server, a user terminal, an equipment management server, and a personnel management server;

FIG. 3 is a block diagram illustrating a schematic configuration of an information processing apparatus;

FIG. 4 is a diagram illustrating an example of a schedule database (DB);

FIG. 5 is a diagram illustrating an example of a vehicle information DB;

FIG. 6 is a diagram illustrating a flow of an information processing method that is performed by the vehicle management server;

FIG. 7 is a diagram illustrating an example of a list of equipment corresponding to purpose of use; and

FIG. 8 is a diagram illustrating a flow of an information processing method according to a modification.

### DESCRIPTION OF THE EMBODIMENTS

An information processing apparatus according to the present disclosure may acquire a use application to privately use a company vehicle that is used by the company for business activity, from a user who is an employee of a company; specifies equipment that is able to be rented out together with the company vehicle to be rented out to the user and that is not provided in the company vehicle, as recommended equipment, based on the use application; and supplies guide information suggesting rental of the recommended equipment to a user terminal. The information processing apparatus may take equipment that is not reserved for rental on a rental date/time of the company vehicle as the recommended equipment, for example.

With the information processing apparatus of the present disclosure, equipment that is not provided in the company vehicle and that can be rented out together with the company vehicle may be rented out to a user. Accordingly, a user may easily use the company vehicle without having to arrange for rental of equipment separately from the use application for the company vehicle, and use of the company vehicle may be promoted.

With the information processing apparatus of the present disclosure, a control unit may acquire equipment information on the company vehicle to be rented out to the user, compare the equipment information with a predetermined list of equipment, and specify equipment that is not included in the equipment information as the recommended equipment. The list of equipment here may be a list of equipment that a user who does not regularly use a vehicle is assumed not to possess or of equipment that is convenient when using a vehicle, such as a car navigation device, a charger for charging a smartphone or the like by being connected to a cigarette socket, a holder for fixing a smartphone to an instrument panel, a spare tire, an inflator and the like. The information processing apparatus of the present disclosure may appropriately suggest rental of equipment that would be of great need to the user.

With the information processing apparatus of the present disclosure, the control unit may determine candidate equipment to be rented out to the user, based on a purpose of use of the company vehicle or information about an occupant who is to get on board, the purpose of use or the information being input by the user, and may specify, as the recommended equipment, the candidate equipment that is able to be rented out on the rental date/time and that is equipment that is not provided in the company vehicle. This enables the information processing apparatus of the present disclosure to suggest rental of appropriate equipment according to the purpose of use of the company vehicle or the information about the occupant.

With the information processing apparatus of the present disclosure, the control unit may take an assist device for infant as the recommended equipment in a case where an occupant who is under a predetermined age is included as the occupant. This enables the information processing apparatus of the present disclosure to suggest rental of an assist device for infant that is used when getting an infant on board, such as a baby car seat or a child car seat.

With the information processing apparatus of the present disclosure, the control unit may acquire attribute information on the user from a personnel management server of the company, and use the attribute information as the information about the occupant. This enables the information processing apparatus of the present disclosure to easily suggest rental of equipment that is suitable for the occupant, by obtaining information about the occupant from an existing server.

The information processing apparatus of the present disclosure may make a reservation for rental of the recommended equipment selected by the user with an equipment management server that manages rental of equipment, in a case where the user returns information indicating selection of recommended equipment that the user wants to rent in response to the guide information. This enables the information processing apparatus of the present disclosure to make a reservation for rental of equipment so that the equipment can be rented out together with the company vehicle.

With the information processing apparatus of the present disclosure, the control unit may transmit information indicating how to use the equipment that is rented out to the user, to the user terminal. This enables the information processing apparatus of the present disclosure to inform the user how to use the equipment that is rented out.

The present disclosure may include, in addition to the information processing apparatus, an information processing method, including same characteristics as the information processing apparatus, and a storage medium storing a program.

<Apparatus Configuration>

Hereinafter, an information processing system provided with an information processing apparatus according to a present embodiment will be described with reference to the drawings. The configuration of the embodiment is an example and is not restrictive.

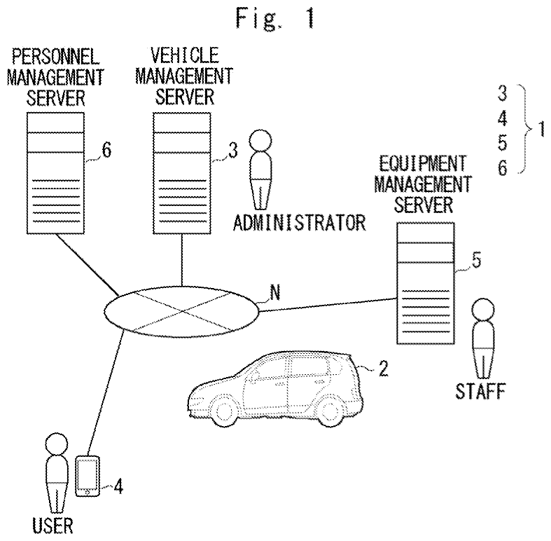

FIG. 1 is a diagram illustrating a schematic configuration of the information processing system (a company vehicle rental system). An information processing system 1 includes a vehicle management server 3 that manages a company vehicle (a vehicle) 2, a user terminal 4 that is used by a user who applies for rental of the company vehicle 2, an equipment management server 5 that manages equipment to be rented out to the user, and a personnel management server 6 that manages personnel information on the user. The information processing system 1 performs rental of the company vehicle 2 that is owned by a firm (a company) to be used for business activity of the firm, for personal use by a user. Because the company vehicle is a vehicle that is normally used for business activity, the company vehicle possibly does not include equipment that is suitable for personal use. Accordingly, the vehicle management server 3 of the present embodiment suggests to the user information about equipment that can be rented out together with the company vehicle. For example, when occupants who get on board with the user include an infant, rental of a child car seat or a baby car seat is suggested. The occupants are exemplified by the driver and passenger of the company car 2. The vehicle management server 3 is managed by the company, for example. The equipment management server 5 is managed by a rental operator that rents out various goods, for example.

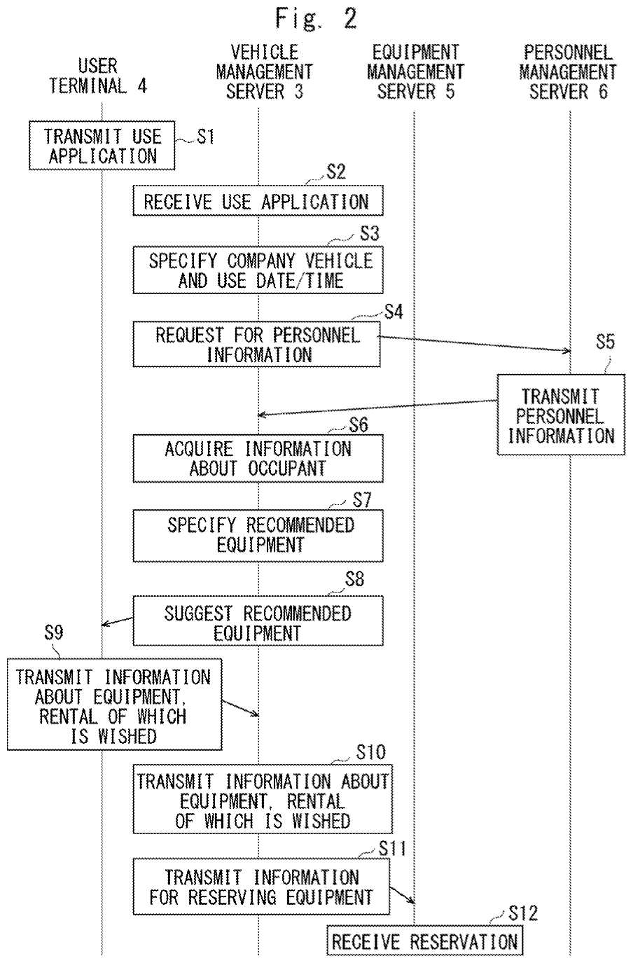

FIG. 2 is a diagram illustrating a sequence of processes that are performed by the vehicle management server 3, the user terminal 4, the equipment management server 5, and the personnel management server 6. In the case where a user who is an employee of the company wishes to use the company vehicle 2, the user operates the user terminal 4, and transmits a use application for the company vehicle 2 from the user terminal 4 to the vehicle management server 3 (S1).

The vehicle management server 3 receives the use application from the user terminal 4 (S2), and specifies the company vehicle to be rented cut to the user and a rental date/time based on the use application (S3).

In the case where the user who submitted the use application accepts use of the personnel information, the vehicle management server 3 requests the personnel management server 6 for the personnel information on the user (S4). The personnel management server 6 receiving the request transmits information (an example of the attribute information on the user) about a family structure of the user and ages of family members, for example, to the vehicle management server 3 (S5). The vehicle management server 3 acquires the information transmitted from the personnel management server 6 as the information about occupant (S6). Additionally, the information about occupant may be information input by the user and received from the user terminal 4, without being limited to be acquired from the personnel management server 6. The attribute information on the user including the information about occupant may be included in the use application. In this manner, the personnel management server 6 may be omitted, and the information about occupant may be acquired from the user terminal 4.

Furthermore, based on the use application and the information about occupant, the vehicle management server 3 specifies equipment that is not provided in the company vehicle and that can be rented out on a same date/time as the company vehicle, as recommended equipment (37).

The vehicle management server 3 transmits guide information suggesting rental of the recommended equipment specified in step S4 to the user terminal (S8).

In the case where the user who checked the guide information wishes for rental, information indicating selection of recommended equipment, rental of which is wished, is returned from the user terminal 4 to the vehicle management server 3 (39).

The vehicle management server 3 receives information about the equipment that the user wants to rent (S10), and transmits information for reserving rental of the equipment to the equipment management server 5 (S11). The equipment management server 5 receives the reservation (S12), and staff of the equipment management server 5 equips the company vehicle 2 with the reserved equipment and performs rental to the user.

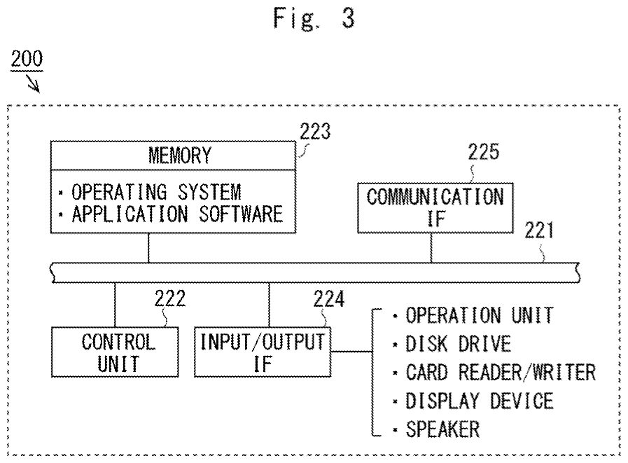

In the present embodiment, the vehicle management server 3, the user terminal 4, the equipment management server 5, and the personnel management server 6 are each an information processing apparatus (a computer). These apparatuses 3, 4, 5, 6 include a same hardware configuration as an information processing apparatus 200, and the hardware configuration will thus be described with reference to FIG. 3. The information processing apparatus 200 is a computer that includes a control unit 222, a memory 223, an input/output interface (IF) 224, and a communication IF 225 that are interconnected by a connection bus 221. The control unit 222 controls the entire apparatus by processing information that is input and outputting a processing result, for example. The control unit 222 is referred to also as a processor, a central processing unit (CPU), or a micro-processing unit (MPU). The control unit 222 may be a single processor, or may include a plurality of processors (a multi-processor). A multicore configuration including a plurality of cores in a single chip connected by a single socket may also be adopted.

The memory 223 includes a main memory and an auxiliary memory. The main memory is used as a work area for the control unit 222, a storage area that temporarily stores information that is processed by the control unit 222, and a buffer area for communication data. The main memory is a storage medium used by the control unit 222 to cache programs and data and to expand a work area, for example. The main memory includes a random access memory (RAM), a read only memory (ROM), and a flash memory, for example. The auxiliary memory is a storage medium that stores programs to be executed by the control unit 222, data to be used for information processing, setup information for operations, and the like. The auxiliary memory is a hard-disk drive (HDD), a solid state drive (SSD), an erasable programmable ROM (EPROM), a flash memory, an USB memory, a memory card or the like, for example.

The input/output IF 224 is an interface for inputting/outputting data to/from an appliance that is connected to the information processing apparatus 200. For example, the input/output IF 224 performs input/output of data with appliances such as an operation unit, a disk drive that reads data from a storage medium such as a CD or a DVD, a card reader/writer, a display device, and a speaker. The operation unit is an input unit, such as an input button, a dial or a touch panel, to which information for the information processing apparatus 200 is input by operation of an occupant. The display device is an output unit that outputs and displays information about a seat to an occupant, for example.

The communication IF 225 is an interface (a communication module) that performs communication with another device over a communication line N, and is referred to also as a communication control unit (CCU). For example, the communication IF 225 performs communication by a wireless communication method such as Worldwide Interoperability for Microwave Access (WiMAX), Long Term Evolution (LTE), Wi-Fi (registered trademark), Bluetooth (registered trademark) or the like. Additionally, structural elements of the information processing apparatus 200 illustrated in FIG. 3 may each be provided in plurality, or some structural elements may be omitted.

Each apparatus 3, 4, 5, 6 as the information processing apparatus 200 performs the processes illustrated in FIG. 2 by executing an application program by the control unit 222. Additionally, each process may be performed by a single control unit 222 or by a plurality of processors. In the case where functions of a plurality of processing units are to be implemented by a single processor, such functions may be implemented by a technique of multi-tasking or multi-threading, for example. Additionally, one, some or all of the processing units mentioned above may be formed as hardware such as a dedicated large scale integration (LSI), such as a digital signal processor (DSP), an application specific integrated circuit (ASIC) or a field-programmable gate array (FPGA), a logic circuit, or another digital circuit. Furthermore, at least one of the processing units may include an analog circuit.

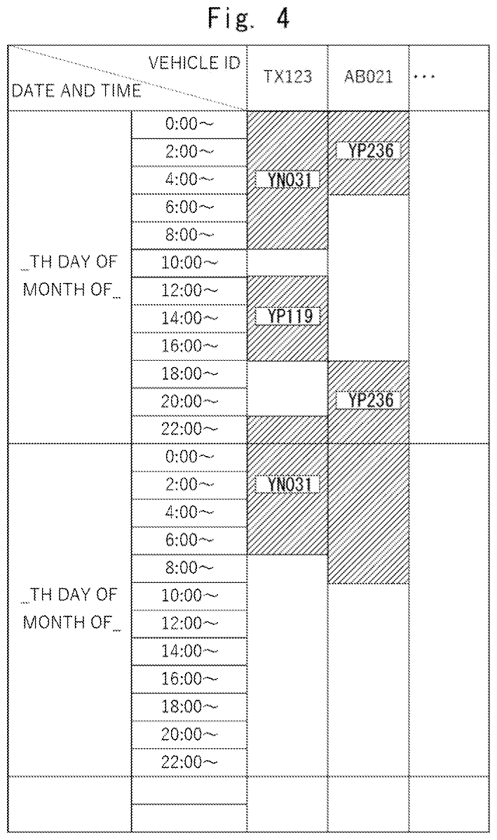

FIG. 4 is a diagram illustrating an example of a schedule database (DB) that is stored in the memory 223 of the vehicle management server 3. The schedule DB records, for each vehicle ID for identifying a company vehicle, a use date/time when the company vehicle 2 is rented out. In FIG. 4, shaded parts indicate periods of use, and a user ID recorded in a shaded cell indicates a user who uses the company vehicle 2. For example, in the example in FIG. 4, it is indicated that a company vehicle 2 whose vehicle ID is TX123 is used by a user YN031 until 10:00 on ______th day of month of and is used next by a user YP119 from 12:00 to 18:00 on __th day of month of ______.

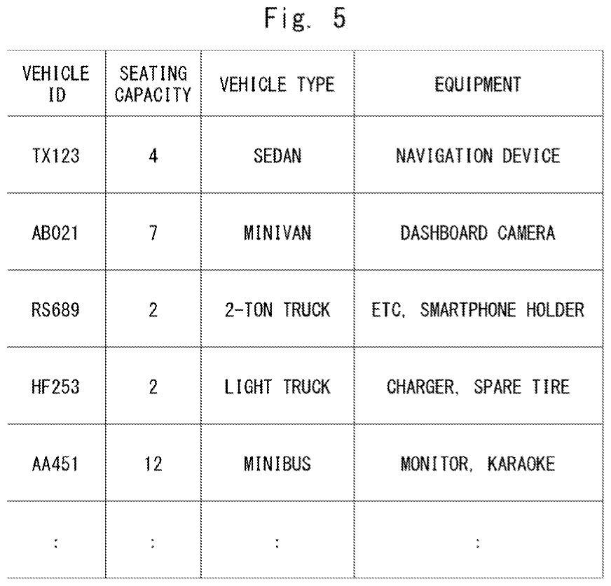

Furthermore, FIG. 5 is a diagram illustrating an example of a vehicle information DB that is stored in the memory 223 of the vehicle management server 3. The vehicle information DB in FIG. 5 stores, for each vehicle ID of the company vehicle 2, information about a seating capacity, a type, and equipment that is provided in the company vehicle 2.

<Information Processing Method>

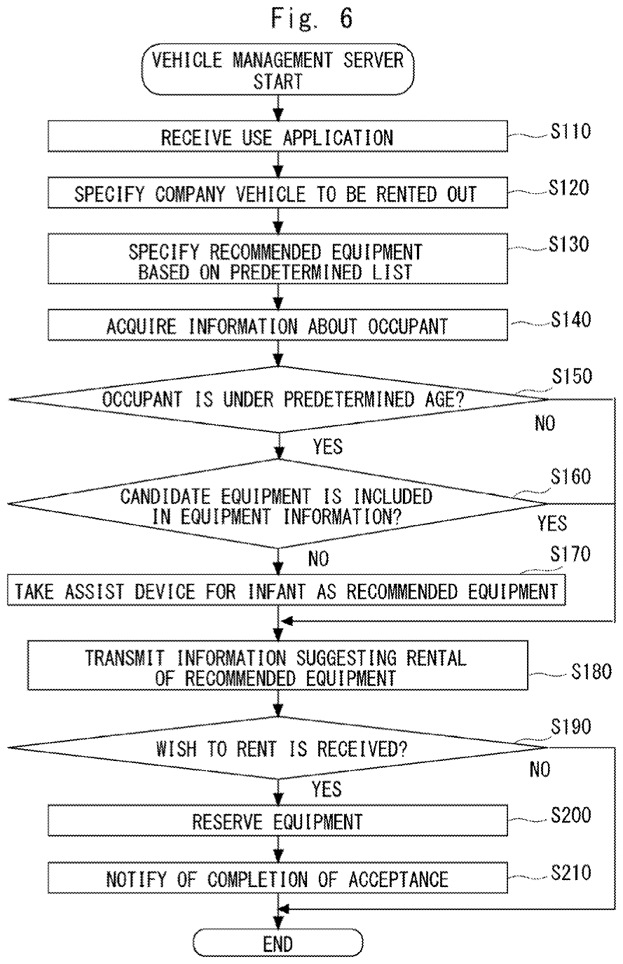

FIG. 6 is a diagram illustrating a flow of an information processing method that is performed by the vehicle management server 3. The vehicle management server 3 starts the process in FIG. 6 when a use application is received from the user terminal 4.

In step S110, the control unit 222 of the vehicle management server 3 receives a use application for a user to privately use a company vehicle from the user terminal 4. The use application here is information indicating requirements and the like regarding a company vehicle, rental of which is wished, such as identification information (a user ID) of the user who wants to rent the vehicle, number of occupants, a vehicle type, and a use date/time. The use application may also be acquired from other than the user terminal 4.

In step S120, the control unit 222 refers to the schedule DB stored in the memory 223, and extracts a company vehicle 2 for which another use reservation is not fixed for the use date/time indicated in the use application, or in other words, an available company vehicle 2. Furthermore, the control unit 222 refers to the vehicle information DB, and specifies a company vehicle 2 that satisfies the number of occupants and the type that are indicated in the use application, among available company vehicles 2. For example, a company vehicle 2 that satisfies the number of occupants and the type that are indicated in the use application, such as a minivan that allows four occupants to get on board or a 2-ton truck that allows two occupants to get on board, is specified.

In step S130, the control unit 222 reads out equipment information indicating the equipment provided in the company vehicle 2 specified in step S120 from the vehicle information DB, and compares the information with a predetermined list of equipment. Then, the control unit 222 specifies, as recommended equipment, equipment, in the predetermined list of equipment, that is not included in the equipment information and that can be rented out on the same use date/time as the company vehicle. The predetermined list of equipment is a list of equipment that a user who does not regularly use a vehicle is assumed not to possess, such as a car navigation device, a charger for charging a smartphone or the like, and a holder for fixing a smartphone to an instrument panel.

In step S140, the control unit 222 communicates with the personnel management server 6, and acquires as information about occupant, from the personnel information on the user who submitted the use application, information about a family structure and ages of family member.

In step 3150, the control unit 222 determines whether or not an occupant who is under a predetermined age (such as under four) is included as an occupant, based on the information about occupant acquired in step S140.

When positive determination is made in step S150, the control unit 222 proceeds to step S160, takes an assist device for infant as candidate equipment, and determines whether or not the candidate equipment is included in the equipment information, or in other words, whether or not the candidate equipment is provided in the company vehicle to be rented out to the user.

In the case of negative determination in step 3160, the control unit 222 proceeds to step 3170, and takes the assist device for infant as the recommended equipment. Additionally, FIG. 6 illustrates an example where the assist device for infant is taken as the recommended equipment based on the age in the occupant information, but such an example is not restrictive, and other equipment may be taken as the recommended equipment based on the occupant information. For example, when number of family members indicated by the occupant information is three or more, a rear-seat monitor may be taken as the recommended equipment, and in the case where an occupant aged four or above and under 15 is included as an occupant, a portable game machine may be taken as the recommended equipment.

In step S180, the control unit 222 transmits information suggesting rental of the recommended equipment specified in steps S130, S170, to the user terminal 4.

In step 3190, the control unit 222 determines whether or not information indicating the user's wish to rent is received from the user terminal 4 in relation to the recommended equipment and the company vehicle within a predetermined period of time from the suggestion in step 3180. In the case of positive determination in step S190, the control unit 222 proceeds to step S200, and transmits information for making a reservation for the recommended equipment that is selected for rental, to the equipment management server 5.

In step S210, the control unit 222 registers, in the schedule DB, a schedule for rental of the company vehicle 2, rental of which is selected in step S190, and issues a notification of completion of acceptance of the use application to the user terminal 4.

<Effects of Embodiment>

As described above, the vehicle management server 3 of the present embodiment is capable of appropriately suggesting rental of equipment that would be of great need to the user. Furthermore, the vehicle management server 3 of the present embodiment suggests rental of recommended equipment based on a list of equipment that a user who does not regularly use a vehicle is assumed not to possess. Accordingly, equipment that is necessary for the user may be rented out together with the company vehicle, and convenience of the user may be increased.

Even in a case where the company vehicle does not include an assist device for infant, the vehicle management server 3 of the present embodiment suggests rental of the assist device for infant as the recommended equipment when an occupant under a predetermined age is included as the occupant, and a user with an infant may thus easily rent the company vehicle.

As described above, by renting out equipment that is not provided in the company vehicle, use of the company vehicle may be promoted. Furthermore, by renting the equipment from a rental operator, the company may keep down the cost of purchasing and keeping the equipment. The rental operator may get an opportunity to rent out child car seats and the like to users not owning a vehicle, and may obtain the chance to increase number of clients. The rental fee for the equipment may be paid entirely by the user, or may be paid entirely or partially by the company.

<Modification>

In the embodiment described above, the vehicle management server 3 determines the recommended equipment based on the predetermined list of equipment and the information about occupant, but the recommended equipment may be further determined according to the purpose of the user.

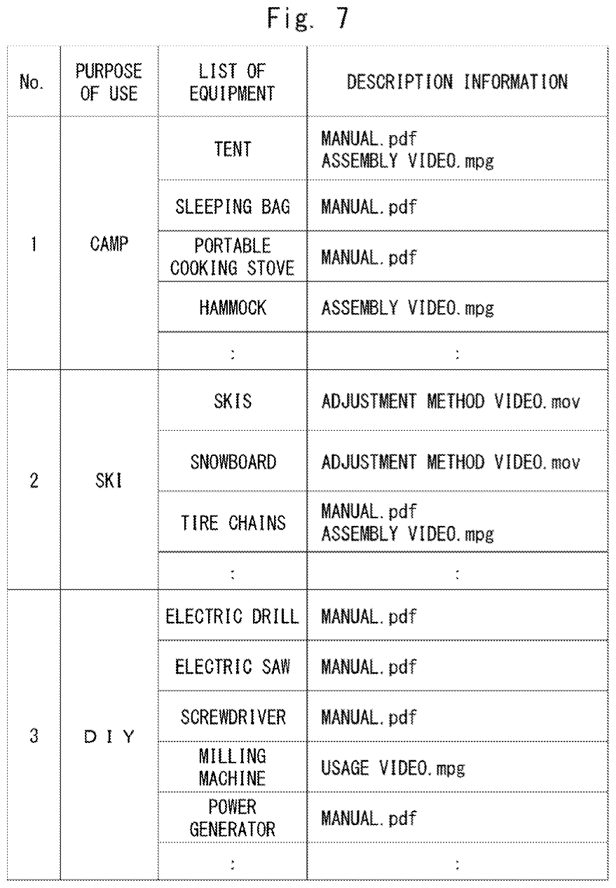

With the vehicle management server 3 of a present modification, a list of equipment corresponding to purpose of use of the company vehicle is stored in advance in the memory 223. FIG. 7 is a diagram illustrating an example of a list of equipment corresponding to purpose of use. In the example in FIG. 7, a purpose of use, a list of equipment, and description information are stored in association with one another. The purpose of use here may be camp, ski, DIY or the like, for example. A list of equipment corresponding to camp may include a tent, a sleeping bag, a portable cooking stove, a hammock and the like. Furthermore, a list of equipment corresponding to DIY may include an electric drill, an electric saw, a disk grinder, a screwdriver, a milling machine, a power generator and the like. Moreover, as the description information, an image illustrating example usage, video information describing usage, and the like may be cited in addition to a manual of the equipment. Furthermore, information that is related to the purpose of use, such as “For DIY, parking lot of DIY store ##, ** Park, riverside park #* are recommended” may be given as the description information.

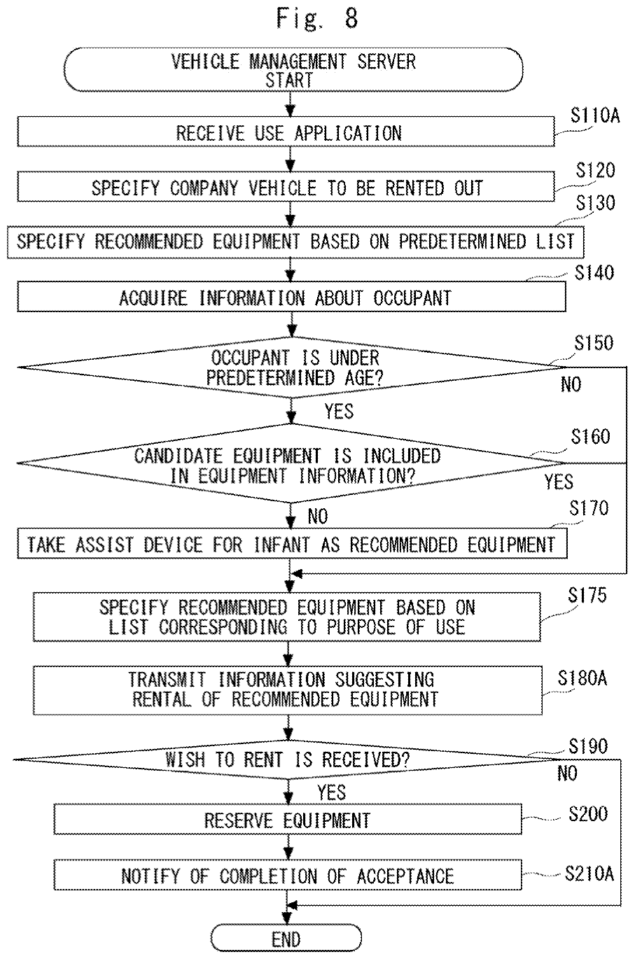

FIG. 8 is a diagram illustrating a flow of an information processing method according to the present modification. According to the present modification, a user inputs the purpose of use to the user terminal 4, and transmits a use application including the purpose of use to the vehicle management server 3. In relation to steps S110A to S170 in FIG. 8, the steps are the same as those in FIG. 6 described above except that the purpose of use is included in the use application that is received in step S110A. Accordingly, description of steps S110A to 3170 is omitted.

In step 3175, the control unit 222 reads out, from the memory 223, a list of equipment corresponding to the purpose of use included in the use application that is acquired in step S110A, compares the list and the equipment information on the company vehicle 2, and specifies equipment not included in the equipment information as the recommended equipment.

In step S180A, the control unit 222 transmits information suggesting rental of the recommended equipment specified in steps S130, S170, S175, to the user terminal 4.

In step S190, the control unit 222 determines whether or not information indicating selection of rental is received from the user terminal 4 in relation to the recommended equipment and the company vehicle within a predetermined period of time from the suggestion in step S180A. In the case of positive determination in step S190, the control unit 222 proceeds to step S200, and transmits, to the equipment management server 5, information for making a reservation for the recommended equipment that is selected for rental.

In step S210A, the control unit 222 registers, in the schedule DB, a schedule for rental of the company vehicle 2, rental of which is selected in step S190, and transmits a notification of completion of acceptance of the use application and the description information to the user terminal 4.

As described above, according to the present modification, rental of appropriate equipment may be suggested according to the purpose of use of the company vehicle. Furthermore, because description information on the equipment to be rented out and the like is transmitted to the user terminal, even unfamiliar equipment may be correctly used, and convenience of the user may be increased.

A control method described in the embodiment above is performed by a processor of a computer reading out a computer program. Such a computer program may be provided to the computer by a non-transitory computer-readable storage medium that can be connected to a system bus of the computer, or may be provided to the computer over a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.). Furthermore, the non-transitory computer-readable storage medium may include read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller including at least one processor configured to execute:
acquiring a use application to privately use a company vehicle that is used by the company for business activity, from a user who is an employee of a company;
specifying equipment that is able to be rented out together with the company vehicle to be rented out to the user and that is not provided in the company vehicle, as recommended equipment, based on the use application; and
supplying guide information suggesting rental of the recommended equipment to a user terminal.

2. The information processing apparatus according to claim 1, wherein the controller acquires equipment information on the company vehicle to be rented cut to the user, compares the equipment information with a predetermined list of equipment, and specifies equipment that is not included in the equipment information as the recommended equipment.

3. The information processing apparatus according to claim 1, wherein the controller specifies, as the recommended equipment, equipment that is able to be rented out to the user, based on a purpose of use of the company vehicle or based on information about an occupant including the user for the company vehicle.

4. The information processing apparatus according to claim 3, wherein the controller specifies an assist device for infant as the recommended equipment in a case where an occupant who is under a predetermined age is included as the occupant.

5. The information processing apparatus according to claim 3, wherein the controller acquires attribute information on the user, and uses the attribute information to specify the recommended equipment.

6. The information processing apparatus according to claim 1, wherein the controller performs a process of reserving rental of the recommended equipment in a case where information indicating a wish of the user to rent the recommended equipment included in the guide information is acquired.

7. The information processing apparatus according to claim 1, wherein the controller supplies information indicating how to use the recommended equipment to the user.

8. An information processing method performed by a controller, the method comprising:
acquiring a use application to privately use a company vehicle that is used by the company for business activity, from a user who is an employee of a company;
specifying equipment that is able to be rented out together with the company vehicle to be rented out to the user and that is not provided in the company vehicle, as recommended equipment, based on the use application; and
supplying guide information suggesting rental of the recommended equipment to a user terminal.

9. The information processing method according to claim 8, wherein the controller acquires equipment information on the company vehicle to be rented cut to the user, compares the equipment information with a predetermined list of equipment, and specifies equipment that is not included in the equipment information as the recommended equipment.

10. The information processing method according to claim 8, wherein the controller specifies, as the recommended equipment, equipment that is able to be rented out to the user, based on a purpose of use of the company vehicle or based on information about an occupant including the user for the company vehicle.

11. The information processing method according to claim 10, wherein the controller specifies an assist device for infant as the recommended equipment in a case where an occupant who is under a predetermined age is included as the occupant.

12. The information processing method according to claim 10, wherein the controller acquires attribute information on the user, and uses the attribute information to specify the recommended equipment.

13. The information processing method according to claim 8, wherein the controller performs a process of reserving rental of the recommended equipment in a case where information indicating a wish of the user to rent the recommended equipment included in the guide information is acquired.

14. The information processing method according to claim 8, wherein the controller supplies information indicating how to use the recommended equipment to the user.

15. A non-transitory storage medium storing a program for causing a controller to execute:
acquiring a use application to privately use a company vehicle that is used by the company for business activity, from a user who is an employee of a company;
specifying equipment that is able to be rented out together with the company vehicle to be rented out to the user and that is not provided in the company vehicle, as recommended equipment, based on the use application; and
supplying guide information suggesting rental of the recommended equipment to a user terminal.

16. The non-transitory storage medium storing the program according to claim 15, wherein the controller acquires equipment information on the company vehicle to be rented out to the user, compares the equipment information with a predetermined list of equipment, and specifies equipment that is not included in the equipment information as the recommended equipment.

17. The non-transitory storage medium storing the program according to claim 15, wherein the controller specifies, as the recommended equipment, equipment that is able to be rented out to the user, based on a purpose of use of the company vehicle or based on information about an occupant including the user for the company vehicle.

18. The non-transitory storage medium storing the program according to claim 17, wherein the controller specifies an assist device for infant as the recommended equipment in a case where an occupant who is under a predetermined age is included as the occupant.

19. The non-transitory storage medium storing the program according to claim 17, wherein the controller acquires attribute information on the user, and uses the attribute information to specify the recommended equipment.

20. The non-transitory storage medium storing the program according to claim 15, wherein the controller performs a process of reserving rental of the recommended equipment in a case where information indicating a wish of the user to rent the recommended equipment included in the guide information is acquired.
